(19) United States
(12) Patent Application Publication
(10) Pub. No.: US 2016/0006954 A1
(43) Pub. Date: Jan. 7, 2016

(54) Multispectral Detection and Processing From a Moving Platform

(71) Applicant: Snap Vision Technologies LLC, Del Mar, CA (US)

(72) Inventor: William Robertson, Del Mar, CA (US)

(21) Appl. No.: 14/792,487

(22) Filed: Jul. 6, 2015

Related U.S. Application Data
(60) Provisional application No. 62/020,767, filed on Jul. 3, 2014.

(51) Int. Cl. H04N 5/33; G01S 17/89

(52) U.S. Cl. CPC H04N 5/332; G01S 17/89

(57) ABSTRACT

A system, method, and computer program for multispectral imaging from a moving platform. The moving platform comprises an imaging sensor to capture images within a field of view. The moving platform further comprises a lens and a filter comprising a plurality of filter segments. The filter segments includes a near infrared filter segment and a Red-Green-Blue filter segment.

### CROSS REFERENCE TO RELATED APPLICATION

This application claims the benefit of U.S. provisional application No. 62/020,767 filed Jul. 3, 2014, which is incorporated by reference as if fully set forth.

### TECHNICAL FIELD

The subject matter described herein relates to the use of a system, method, and computer program for multispectral imaging. More particularly, variations of the current subject matter are directed to a computer program, method, and system for single-sensor multispectral imaging from a moving platform.

### BACKGROUND

Multispectral imaging systems address a large range of research, industrial, and military challenges. The absorption, transmission, and reflectance properties of matter when subject to illumination, from the sun or an artificial source, can be used to detect certain properties of the matter. In addition, coupled physical and special characteristics of the sensed matter can provide additional insights into the state of said matter.

### SUMMARY

A moving platform for vegetation analysis including an imaging sensor that is configured to capture a plurality of images within a field of view. The moving platform further includes a lens having a first side and a second side that is disposed, on the first side, adjacent to the imaging sensor within the field of view. The moving platform also includes a filter having a first side coupled to the imaging sensor and a second side coupled to the lens comprising a plurality of filter segments, the filter segments includes a near infrared filter segment to capture near infrared (NIR) energy and a Red-Green-Blue (RGB) filter segment to capture visible RGB energy.

The image sensor may be a Bayer Red-Green-Blue (RGB) sensor or monochromatic sensor. The near infrared filter segment may pass wavelengths between 700 nm and 1500 nm and the RGB filter segment may pass light between 400 nm and 700 nm segment. In one variant, the near infrared filter segment may comprise a 700 nm high pass segment or a 620 nm high pass segment. In one variant, the RGB filter segment may comprise a 700 nm low pass segment. The filter is further configured to match a quantum efficiency of the imaging sensor to optical transmission of the filter segments to allow for a single exposure time of the imaging sensor.

The filter further generates polarized segments identifying different objects within the target areas. The objects may include vegetation types, disturbed soil for land mines, weapon caches, improvised explosive devices, other man-made objects, fish, other marine life, minerals, human beings, or chemicals.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, with the current subject matter, a moving platform with a multi-spectral imaging assembly can collect a plurality of images in a target area. The collected images are then processed and presented to a user on a display. This approach allows a low cost camera to be adapted into a multi-spectral sensor on a moving platform. This allows the user to have a moving platform that is compact, low weight, and low cost to perform multi-spectral imaging to figure out status of a target area.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a multi-spectral imaging assembly of a moving platform;

FIG. 2 is a system diagram illustrating how the moving platform enables a split filter system to capture a multispectral data set for a target area;

FIG. 3 is a system diagram illustrating the unique reflectance characteristics of vegetation health in the visible and near infrared (NIR) spectrum;

FIG. 4 is a diagram illustrating a sample NIR high pass low pass filter combination over a nominal Bayer filtered sensor;

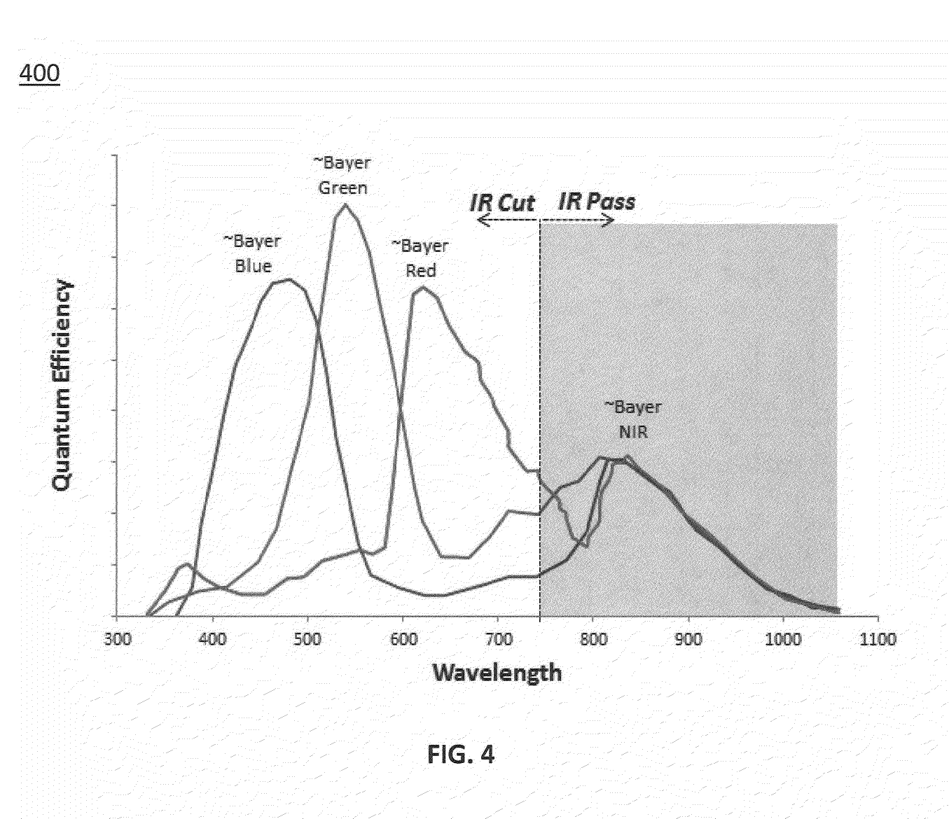

FIG. 5 is a diagram illustrating a standard Red, Green, Blue (RGB) image of a target area;

FIG. 6 is a diagram illustrating processed vegetation health overlaid on a RGB image;

FIG. 7 is a system diagram illustrating an image with processed data highlighting problem areas; and

FIG. 8 is a diagram illustrating a process for multi-spectral detection and processing.

Like reference symbols in the various drawings indicate like elements.

### DETAILED DESCRIPTION

The current subject matter is directed to a moving platform, such as an unmanned aerial vehicle, that carries at least one sensor, such as a complementary metal oxide semiconductor (CMOS) or a charge coupled device (CCD) sensor. A split filter is overlaid over the sensor for detecting wavelengths in the near infrared (NIR) and visible (RGB) spectrums. Images detected by the sensor and filtered through the split filter may be analyzed and processed to determine one or more features relating to a target area that was imaged, for example, to collect multispectral data for non-contact sensing of vegetation. In some other variations, the current subject matter is used to detect disturbed soil for land mines and weapons caches, detect improvised explosive devices and other man-made objects, detect the location of fish and other marine life, detect the presence of certain minerals for mining, detect human beings for search and rescue, military, or law enforcement applications, and detect the presence of certain chemicals.

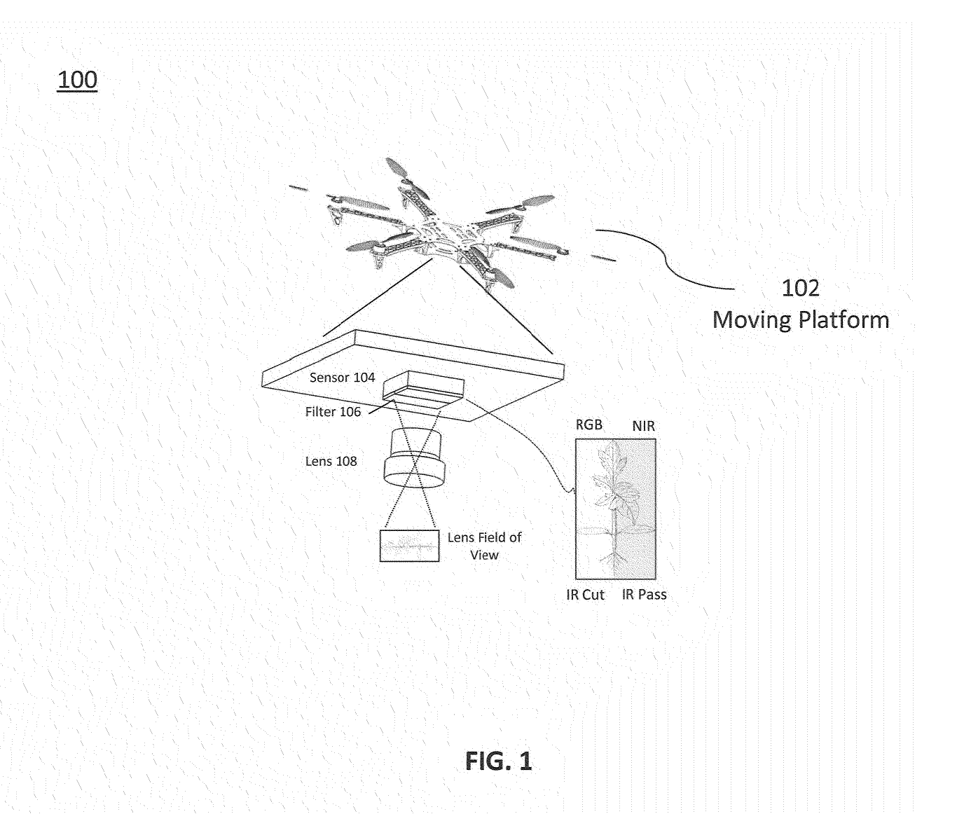

FIG. 1 is a diagram 100 illustrating the multi-spectral imaging assembly of a moving platform 102. The multi-spectral imaging assembly comprises an imaging sensor 104, a filter 106, and a lens 108. The lens 108 presents a lens field of view, through which the data is collected. The lens 108 may be focusable to provide a clear image. The imaging sensor 104 may be a Bayer Red, Green, Blue (RGB) imaging sensor or other RGB sensors. The filter 106 comprises a plurality of filter segments. The filter 106 is adapted to capture RGB data through an IR cut filter segment while capturing near infrared (NIR) data through the adjacent NIR pass filter segment. Thus, the image produced for the imaging sensor is split such that a portion is represented in the RGB spectrum and a portion is represented in the NIR spectrum. The two respective portions are not mirror images or duplicates of each other but instead depict separate areas of the target.

As shown in FIG. 1, the moving platform 102 comprises a single lens 108, a single split filter 106, and a single imaging sensor 104. This variation has the advantage of not relying on the precise alignment of disparate imaging sensors in harsh environments and reducing the number of images that must be combined together. This variation also reduces the weight and cost of the system. In some variations, the moving platform 102 further comprises an RGB imaging assembly aligned with and adjacent to an NIR imaging assembly. In some variations, the moving platform 102 comprises a filter split into three or more segments as narrow resolution filters may be used to look for spectral features.

In some variations, the moving platform 102 includes an autonomous computer-operated drone, a remotely-piloted aircraft, a human-operated aircraft or a ground-based drone. The moving platform can be in a fixed-wing or rotary-wing configuration. In some other variation, the moving platform 102 may be mounted on a pivot applicator sprinkler

In one variation of the current subject matter, the moving platform 102 comprises a multicopter. The flexibility and omni-directional flight capabilities of multicopters may provide advantages to the system. Slow flight speeds will allow more time for sensor detection or a large number of filter segments overlaying the sensor (e.g., three, four, or five filter segments instead of two filter segments). Rotational motion or off axis motions could allow the sensor to cover larger areas and capture overlapping filtered data.

In some variations, the moving platform 102 includes a processor. The processor collects image data generated by a multi-spectral imaging assembly and then sends the image data to a user device. The user device may be a tablet, a computer, a cellular telephone, and the like. The user device then transfers the image data to a storage element for later processing, or it generates a full area stitched image, or both. In some variations, the storage element generates the full area stitched image. In some variations, the moving platform 102 processes the image data to create the full area stitched image and transmits the full area stitched image to the user device.

The moving platform 102 may further comprise additional sensors. In some variations, the additional sensor may be an ambient light sensor. The ambient light sensor detects the amount of sunlight on the moving platform 102. The ambient light detector is located on the top or side of the aerial vehicle such that it will be directly exposed to sunlight. Recording the ambient light may be advantageous because knowing the amount of ambient sunlight in the given conditions may assist the processor or the user in interpreting the data collected from the multi-spectral imaging assembly. In some variations, the ambient light sensor comprises a light emitting diode (LED). The light emitting diode creates an electrical charge based upon the amount of sunlight that contacts it. The processor then measures the electrical charge generated through the light emitting diode to determine the amount of ambient sunlight. These measurements can be utilized to detect clouds and calibrate the data being reflected from the target matter. In some variations, a carrying case for the system could be used for sensor calibration because the carrying case has known reflective properties.

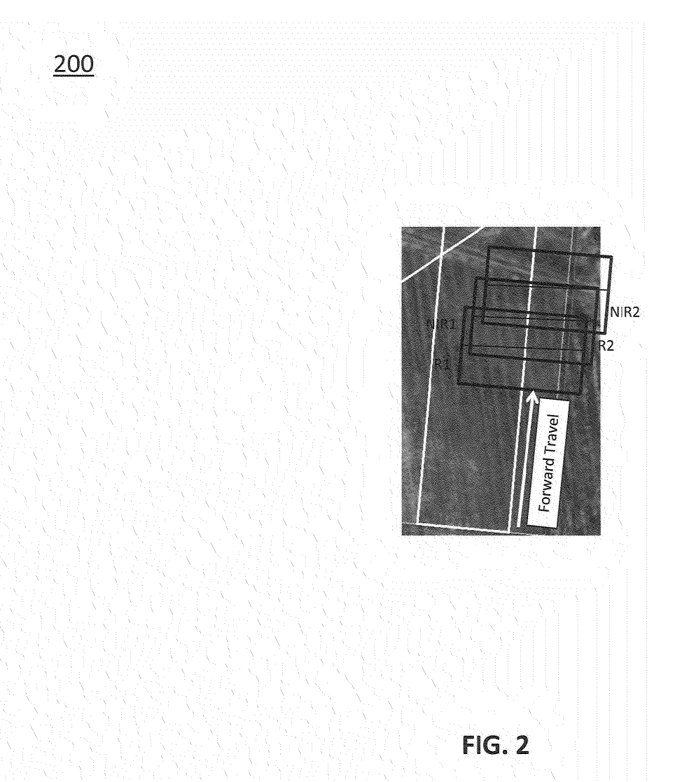

In some variations, the moving platform 102 further comprises a global positioning system (GPS) sensor. The global positioning system sensor provides geo-locational data for the moving platform 102. Global positioning system data assists in maneuvering the moving platform 102 along the planned route, as shown in FIG. 2. Global positioning system data in combination with attitude sensor information (rotational gyros and linear accelerometers) also records the location in which each image was taken so that it can be precisely overlaid onto the map.

FIG. 2 is a diagram 200 illustrating a moving platform moving across a target area. The multi-spectral imaging assembly captures overlapping images as the moving platform moves. As such, all or nearly all of the target area is captured via both the RGB filter (R1 and R2) and the NIR filter (NIR 1 and NIR 2). The processor (which is associated with the moving platform, the user device, or the storage device) then stitches or compiles the data such to create two separate and complete images of the target area. In some variations, the filter segments are aligned with the long axis perpendicular to the direction of motion.

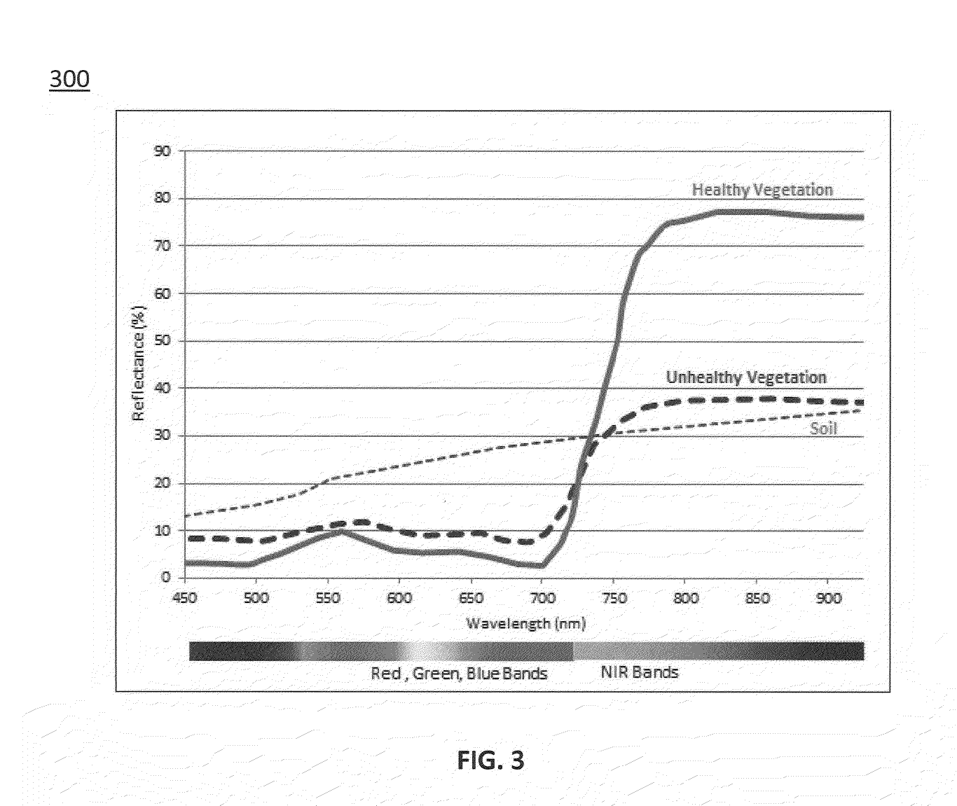

FIG. 3 is a diagram 300 illustrating vegetation health in the visible and near infrared (NIR) spectrum. Unhealthy plants absorb more NIR energy from the sun, and as such reflect fewer NIR photons. Healthy plants do not absorb more heat from the sun, and as such reflect more NIR photons. The images captured via the NIR filter segment can be analyzed using known ratios and vegetation analysis techniques such as Normalized Difference Vegetation Index (NDVI) to measure the healthiness of plants within the target area.

In some variations, the computer program calculates and presents a graphical representation of the NDVI. NDVI is a graphical indicator that assesses the healthiness or unhealthiness of vegetation within the target area. The computer program calculates the NDVI by taking the ratio of NIR less the red value in RGB to NIR plus the red value in RGB. The calculated NDVI values for each segment of data therefore lie between −1.0 and +1.0. In addition to the NDVI, many other vegetation spectral ratios have been presented in prior works. The other vegetation spectral ratios may include a Simple Ratio (SR), Enhanced Vegetation Index (EVI), a Difference Vegetation Index (DVI), or the like. The outlined filtering hardware may be configured to capture data for any ratio using bands of visible and NIR energy.

In some variations, the split filter is balanced to ensure a single integration time, also known as exposure time. This will prevent overexposure or underexposure of various sections of the imaging sensor. The split filter is balanced by matching the quantum efficiency of the imaging sensor to optical transmission of the filter segments allowed through each filter segment. A balanced split filter will reduce photons passing through the filter in spectral regions where the imaging sensor has high quantum efficiency and let freely through where the sensor has low quantum efficiency. In some other variations, the split filter is not balanced.

In some variations, the filter could include polarized segments to detect man-made versus natural objects. In some variations, the filter generates polarized areas that can be used to classify vegetation types as some vegetation types create a spectral reflection while others do not. For example, this polarization could also be utilized to determine if corn plants have begun to produce tassels.

The imaging sensor 104 collects the data that passes through the filter 106. The imaging sensor 104 may be a still camera, video camera, photodetector, or the like. In some variations, the rate of the data capture is 30 frames per second. In some other variations, the rate of data captured could be more or less, or variable depending on conditions and user input.

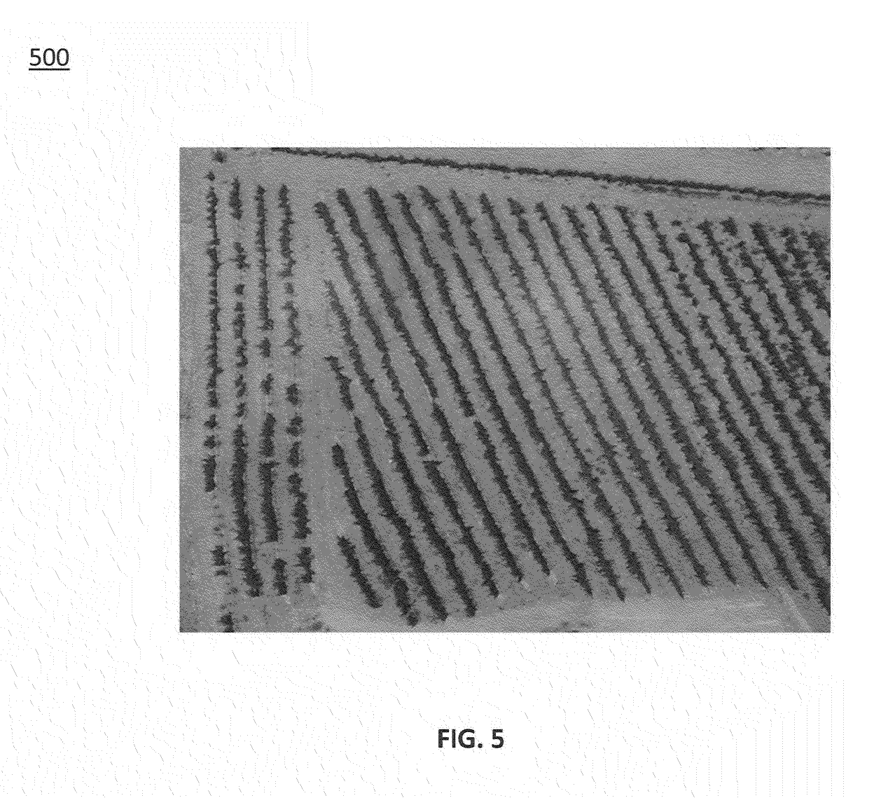

FIG. 5 is an exemplary image 500 illustrating a standard RGB image of a target area.

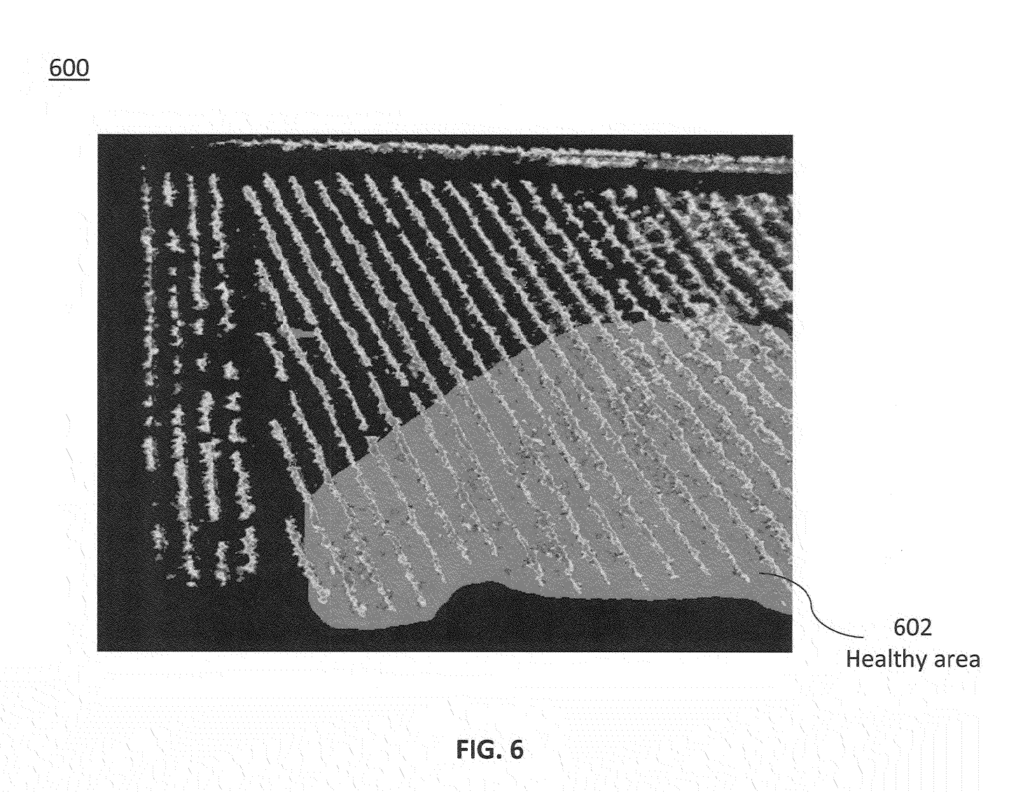

FIG. 6 is an exemplary image 600 illustrating processed vegetation health overlaid on a RGB image. The vegetation health is determined by the NDVI. The healthy area 602 is identified and shown in green.

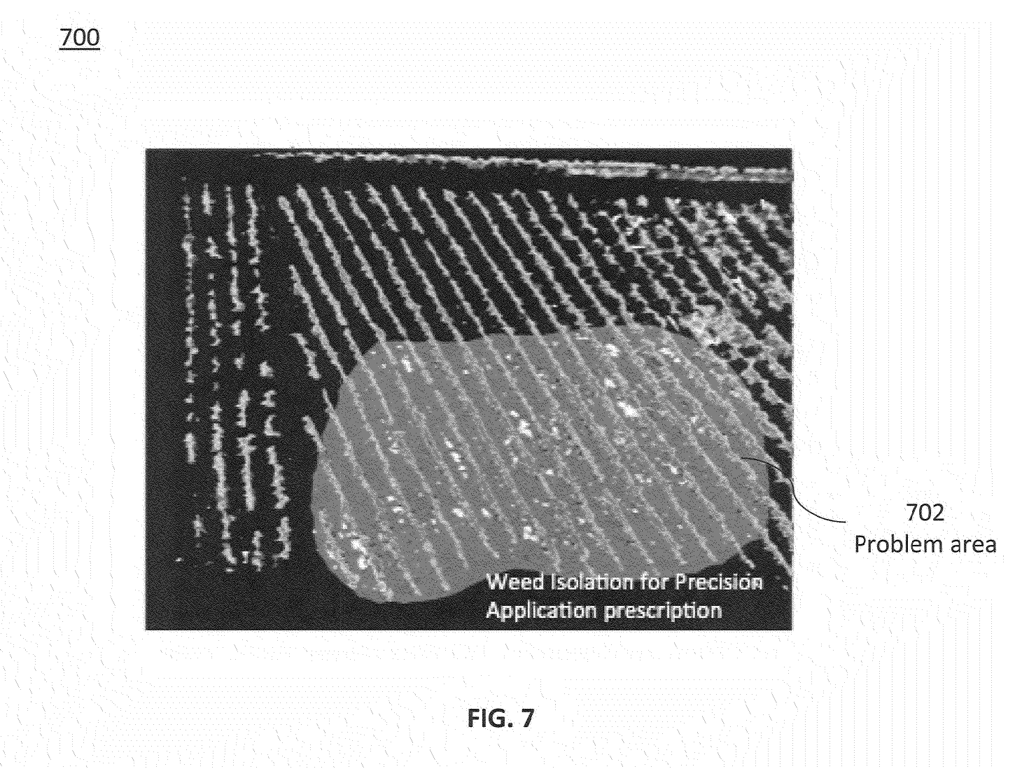

FIG. 7 is an exemplary image 700 illustrating an image with processed data highlighting problem areas. The problem area 702 is labeled as weed area.

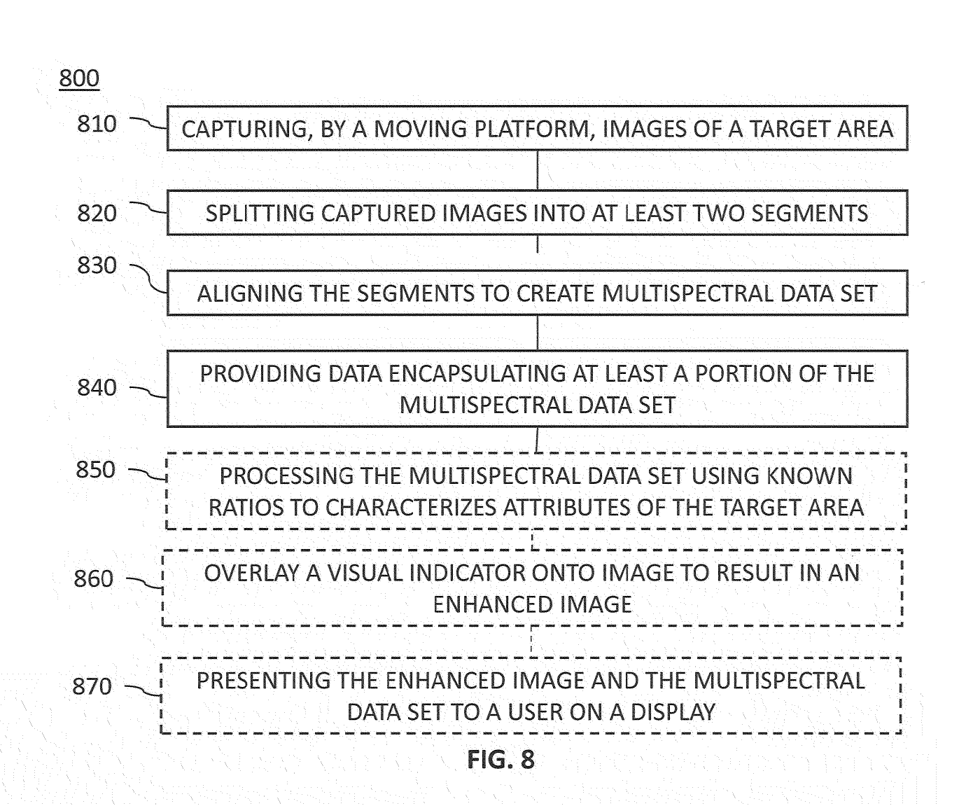

FIG. 8 is a process flow diagram 800 in which, at 810, capturing, by a moving platform, a plurality of images of a target area disposed in a field of view. Optionally, the collected plurality of images may be transmitted or stored at the moving platform, a user device, or a storage medium. Subsequently, at 820, splitting each captured image into at least two segments, the at least two segments includes a near infrared filter segment to capture near infrared (NIR) energy and a RGB filter segment to capture visible RGB energy. The near infrared filter segment comprises wavelengths between 700 nm and 1500 nm segment and the RGB filter segment comprises wavelengths between 400 nm and 700 nm segment. In one variant, the near infrared filter segment may comprise a 700 nm high pass segment or a 620 nm high pass segment. In one variant, the RGB filter segment may comprise a 700 nm low pass segment. At 830, aligning the near infrared filter segments and the RGB filter segments from one collection point to at least one surrounding collection point to create a multispectral data set. At 840, providing data encapsulating at least a portion of the multispectral data set. The providing data comprises at least one of: displaying the data, storing the data, loading the data into memory, or transmitting the data over a communication network to a remote computing system. Optionally, at 850, processing the multispectral data set using known ratios to characterizes objects of the target area. In one variation, the known ratio may be a Normalized Different Vegetation Index (NDVI), a Simple Ratio (SR), Enhanced Vegetation Index (EVI), and a Difference Vegetation Index (DVI). Optionally, at 860, overlaying a visual indicator onto an image of the target area to result in an enhanced image. The overlaying includes determining, based on the multispectral data set and the known ratios, a status of a portion of the target area and generating, based on the status of the portion of the target area, the visual indicator identifying the status of the portion of the target area. Optionally, at 870, presenting the enhanced image and the multispectral data to a user on a display.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of” A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An apparatus for vegetation analysis comprising:
at least one programmable data processor;
memory storing instructions for execution by the at least one programmable data processor;
an imaging sensor coupled to the at least one programmable data processor that is configured to capture a plurality of images within a field of view;
a lens having a first side and a second side that is disposed, on the first side, adjacent to the imaging sensor within the field of view; and
a filter having a first side coupled to the imaging sensor and a second side coupled to the lens comprising a plurality of filter segments, the filter segments includes a near infrared filter segment to capture near infrared (NIR) energy and a Red-Green-Blue (RGB) filter segment to capture visible RGB energy.

2. The apparatus of claim 1, wherein the imaging sensor comprises at least one of a Bayer Red-Green-Blue (RGB) sensor or a monochromatic sensor.

3. The apparatus of claim 1, wherein the near infrared filter segment may comprise a 700 nm high pass segment or a 620 nm high pass segment.

4. The apparatus of claim 3, wherein the RGB filter segment may comprise a 700 nm low pass segment.

5. The apparatus of claim 1, wherein the filter is configured to match quantum efficiency of the imaging sensor to optical transmission of the filter segments to allow for a single exposure time of the imaging sensor.

6. The apparatus of claim 1, wherein the filter generates at least one polarized segment identifying different objects within the target area.

7. The apparatus of claim 6, wherein the objects includes at least one of vegetation types, disturbed soil for land mines, weapon caches, improvised explosive devices, other man-made objects, fish, other marine life, minerals, human beings, or chemicals.

8. The apparatus of claim 1, wherein the apparatus is at least one of: an autonomous computer-operated drone, a remotely-piloted aircraft, a human-operated aircraft, a ground-based drone, a multicopter, or a pivot applicator sprinkler.

9. A method comprising:
capturing, by a moving platform, a plurality of images of a target area disposed in a field of view;
splitting each captured image into at least two segments, the at least two segments includes a near infrared filter segment to capture near infrared (NIR) energy and a RGB filter segment to capture visible RGB energy.;
aligning the near infrared filter segments and the RGB filter segments to create a multispectral data set; and
providing data encapsulating at least a portion of the multispectral data set.

10. The method of claim 9, wherein the providing data comprises at least one of: displaying the data, storing the data, loading the data into memory, or transmitting the data over a communication network to a remote computing system.

11. The method of claim 9, wherein the near infrared filter segment may comprise a 700 nm high pass segment or a 620 nm high pass segment.

12. The apparatus of claim 11, wherein the RGB filter segment may comprise a 700 nm low pass segment.

13. The method of claim 9, further comprising:
processing the multispectral data set using known ratios to characterizes objects of the target area;
overlaying a visual indicator onto an image of the target area to result in an enhanced image; and
presenting the enhanced image and the multispectral data to a user on a display.

14. The method of claim 13, wherein the overlaying comprises:
determining, based on the multispectral data set and the known ratios, a status of a portion of the target area;
generating, based on the status of the portion of the target area, the visual indicator identifying the status of the portion of the target area.

15. The method of claim 13, wherein the known ratios includes at least one of: a Normalized Different Vegetation Index (NDVI), a Simple Ratio (SR), Enhanced Vegetation Index (EVI), and a Difference Vegetation Index (DVI).

16. The method of claim 13, wherein the visual indicator comprises at least one of a healthy area and an unhealthy area.

17. A non-transitory computer program product storing instructions which, when executed by at least one hardware data processors, result in operations comprising:
capturing, by a moving platform, a plurality of images of a target area disposed in a field of view;
splitting each captured image into at least two segments, the at least two segments includes a near infrared filter segment to capture near infrared (NIR) energy and a RGB filter segment to capture visible RGB energy;
aligning the near infrared filter segments and the RGB filter segments to create a multispectral data set; and
providing data encapsulating at least a portion of the multispectral data set.
